(19) United States
(12) Patent Application Publication
(10) Pub. No.: US 2024/0124621 A1
(43) Pub. Date: Apr. 18, 2024

(54) CURABLE COMPOSITION AND USE THEREOF

(71) Applicant: Henkel AG & Co. KGaA, Duesseldorf (DE)

(72) Inventors: Weiwei Xun, Shanghai (CN); Qili Wu, Shanghai (CN); Bin Zhao, Shanghai (CN); Lvyuan Ye, Shanghai (CN)

(21) Appl. No.: 18/515,628

(22) Filed: Nov. 21, 2023

Related U.S. Application Data
(63) Continuation of application No. PCT/CN2021/095239, filed on May 21, 2021.

(51) Int. Cl. C08F 20/06; C08F 2/44; C08F 4/02; C08F 22/10; C08K 5/5337

(52) U.S. Cl. CPC C08F 20/06; C08F 2/44; C08F 4/027; C08F 22/1006; C08K 5/5337

(57) ABSTRACT

The present invention provides a curable composition comprising (A) at least one (meth)acrylate; (B) at least one diaryliodonium salt; and (C) at least one latent amine catalyst, which can thermally be curable at a temperature of lower than 100° C. and can be also thermally curable and radiation curable. The present curable composition exhibits favorable adhesion strength on various substrates when cured.

### TECHNICAL FIELD

The present invention relates to a curable composition, the cured product and use thereof.

### BACKGROUND OF THE INVENTION

At present, UV curable adhesives have been successfully applied in many fields of industrial assembly, especially high-tech industries where fast assembly is required, such as manufacturing electronic device, optical instruments, etc. UV curable adhesives are also widely used in the commodity sector, such as manufacturing glass furniture, toys, jewelry and other decorations.

However, in some specific application fields using the conventional UV curable adhesives, some problems may be encountered. For example, shadow areas may exist between the liquid crystal panel and the substrate, that is, areas that light cannot transmit or penetrate, UV/visible light cannot transmit through these areas, thus the adhesives cannot be cured completely, and may cause problems such as corrosion, aging fatigue or peeling of unbonded edges.

In the case of the free-radical curing system, a photo-radical generating agent and a (meth)acrylate resin are main components; the system has a characteristic of quickly curing after UV irradiation but has problems such as having generally low adhesion strength. On the other hand, the cation curing system is constituted of a photo-acid forming agent such as diaryliodonium salt and a triaryl sulfonium salt, and an epoxy resin, an oxetane resin, a vinyl ether resin, or the like, which has a cation polymerization property, and the photo-acid forming agent generates an acid in light irradiation to make a cation polymerizable resin cured. In the case of cation curing, the system has characteristics such as quick curing property and high adhesion strength but has problems such as generating curing defect due to moisture or a subtle basic stain in the surface of an adherent and causing erosion when the system is used for an adherent made of a metal or an inorganic material since a strong acid remains in the system.

In view of the above, it is an object of the present invention to provide a curable composition capable of being thermally cured at a temperature of lower than 100° C. and exhibiting favorable adhesion strength on various substrates when cured. It is yet another object of the present invention to provide a curable composition which is thermally curable and radiation curable and exhibiting favorable adhesion strength on various substrates when cured.

### SUMMARY OF THE INVENTION

Disclosed herein is a curable composition comprising:
(A) at least one (meth)acrylate;
(B) at least one diaryliodonium salt; and
(C) at least one latent amine catalyst.

Also disclosed herein is the cured product of the curable composition according to the present invention.

Also disclosed herein is the article comprising the cured product of the curable composition according to the present invention.

Also disclosed herein is the electronic device comprising the article according to the present invention.

Also disclosed herein is the use of the curable composition and the article according to the present invention in manufacturing electronic devices.

Other features and aspects of the subject matter are set forth in greater detail below.

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “room temperature” as used herein refers to a temperature of about 20° C. to about 25° C., preferably about 25° C.

Unless specified otherwise, the recitation of numerical end points includes all numbers and fractions subsumed within the respective ranges, as well as the recited end points.

All references cited in the present specification are hereby incorporated by reference in their entirety.

Unless otherwise defined, all terms used in the present invention, including technical and scientific terms, have the meaning as commonly understood by one of the ordinary skilled in the art to which this invention belongs.

In one aspect, the present disclosure is generally directed to a curable composition:
(A) at least one (meth)acrylate;
(B) at least one diaryliodonium salt; and
(C) at least one latent amine catalyst.

### (A) (Meth)acrylate

According to the present invention, the curable composition comprises (A) at least one (meth)acrylate.

The component (A) is selected from monofunctional (meth)acrylate monomer, polyfunctional (meth)acrylate monomer, and oligomer thereof.

Examples of monofunctional (meth)acrylate monomer used as component (A) in the present invention include but not limited to methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth) acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth) acrylate, tricyclodecanyl (meth)acrylate, dicyclopentenyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-phenoxyethyh acrylate, 2-aminoethyl (meth)acrylate, dimethylaminoethyl (meth)acrylate, diethylaminoethyl (meth)acrylate, and combinations thereof.

Examples of polyfunctional (meth)acrylate monomer used as component (A) in the present invention include but not limited to ethoxylated trimethylolpropane triacrylate, trimethylol propane tri(meth)acrylate, dipentaerythritol pentaacrylate, pentaerythritol triacrylate, 1,6-hexanedioldiacrylate, neopentyl glycol diacrylate, pentaerythritol tetraacrylate, 1,4-butanediol diacrylate, trimethylolpropane tri(meth)acrylate, tri(propylene glycol) diacrylate, neopentyl glycol propoxylate diacrylate, diethylene glycol dimethacrylate, bisphenol A diglycidyl ether di(meth)acrylate, dicyclopentadiene dimethanol di(meth)acrylate, tricyclodecanedimethanol diacrylate, and combinations thereof.

In some embodiments, urethane (meth)acrylate oligomer can be used as component (A) in the present invention. Urethane (meth)acrylates are well known to a person skilled in the art, they may for example be obtained by reaction of diisocyanates, preferably aliphatic diisocyanates, with hydroxy(meth)acrylates, or may for example be obtained by reaction of diisocyanates, preferably aliphatic diisocyanates, with hydroxy(meth)acrylates and polyols.

The component (A) may be used either alone, or in combinations of two or more different compounds.

Examples of commercially available products of the component (A) include SR 833S from Sartomer, and PEP 9000 from Negami Chemical Industrial Co., Ltd.

According to the present invention, the component (A) may present in an amount of from 50% to 95% by weight, preferably from 60% to 85% by weight, based on the total weight of the composition.

### (B) Diaryliodonium Salt

According to the present invention, the curable composition comprises (B) at least one diaryliodonium salt.

In some embodiments, the diaryliodonium salt can be selected from diphenyl iodonium phosphate and diphenyl iodonium borate. Examples of diphenyl iodonium phosphate are selected from (4-methylphenyl)-[4-(2-methylpropyl)phenyl]iodonium hexafluorophosphate, (4-methylphenyl)-phenyliodonium hexafluorophosphate, bis(4-tert-butylphenyl)iodonium hexafluorophosphate, bis(4-methylphenyl)iodonium hexafluorophosphate, (4-ethylphenyl)-[4-(2-methylpropyl)phenyl]iodoniumhexafluorophosphate, bis(t-butylphenyl)iodonium hexafluorophosphate, bis(3,4-dimethylphenyl)iodonium hexafluorophosphate. Examples of diphenyl iodonium borate are (4-isopropylphenyl)(p-tolyl)iodonium tetrakis(perfluorophenyl)borate, (4-methylphenyl)-(2-propan-2-ylphenyl)iodonium tetrakis(2,3,4,5,6-pentafluorophenyl)boranuide, bis(2-methylphenyl)iodonium tetrakis(2,3,4,5,6-pentafluorophenyl)boranuide, (4-methylphenyl)-[4-(2-methylpropyl)phenyl]iodonium tetrakis(2,3,4,5,6-pentafluorophenyl)boranuide, bis(4-dodecylphenyl)iodonium tetrakis(2,3,4,5,6-pentafluorophenyl)boranuide, bis(2-dodecylphenyl)iodonium tetrakis(2,3,4,5,6-pentafluorophenyl)boranuide, (2-methylphenyl)-(2-propan-2-ylphenyl)iodonium tetrakis(2,3,4,5,6-pentafluorophenyl)boranuide, bis(2-tert-butylphenyl)iodonium tetrakis(2,3,4,5,6-pentafluorophenyl)boranuide, 1,4-di(3-phenylpropyl)-2,3-diperfluorophenyl-1,4-diiodobutadiene, butyl(triphenyl)boranuide (4-cyclohexylphenyl)-(4-methylphenyl)iodonium, (4-hexylphenyl)-phenyliodonium tetraphenylboranuide, (4-cyclohexylphenyl)-phenyliodonium tetraphenylboranuide.

The component (B) may be used either alone, or in combinations of two or more different compounds.

The component (B) can be produced using conventionally known methods. Commercial products can be available as well. Examples of commercially available products of the component (B) include Rhodorsil Photoinitiator 2074 from RHODIA INC, and Omnicat 250 from IGM Resins.

According to the present invention, the component (B) may present in an amount of from larger than 0% to less than 3% by weight, preferably from 0.001% to 2% by weight, more preferably from 0.01% to 2% by weight based on the total weight of the composition.

In particularly preferred embodiments, the component (B) my present in an amount of from larger than 1% by weight based on the total weight of the composition. When the component (B) is in an amount of from larger than 1% by weight, the composition is capable of thermally curing at temperature no more than 80° C.

### (C) Latent Amine Catalyst

According to the present invention, the curable composition comprises (C) at least one latent amine catalyst. Latent amine catalyst refers to an amine catalyst that is slowly released or diffuses from a barrier at room temperature. The release or diffusion of the amine catalyst may be accelerated, for example at increased temperature, radiation, or force.

Examples of latent amine catalyst may include but not limit to amine adduct latent catalyst, preferably obtained by the reaction products of an amine compound with an epoxy compound, an isocyanate compound and/or a urea compound, core-shell type latent amine catalyst, master batch type latent amine catalyst, and combinations thereof, preferably core-shell type latent amine catalyst.

Examples of an epoxy compound used as one of raw materials for manufacturing the amine adduct latent catalyst (amine-epoxy-adduct based type latent catalyst) may include polyglycidyl ether obtained by the reaction between polyhydric phenol such as bisphenol A, bisphenol F, catechol, and resorcinol, or polyhydric alcohol such as glycerin and polyethylene glycol, and epichlorohydrin, glycidyl ether ester obtained by the reaction between hydroxycarboxylic acid such as p-hydroxybenzoic acid and 3-hydroxynaphthoic acid, and epichlorohydrin, polyglycidyl ester obtained by the reaction between polycarboxylic acid such as phthalic acid and terephthalic acid, and epichlorohydrin, and a glycidyl amine compound obtained by the reaction between 4,4′-diaminodiphenylmethane, m-aminophenol, or the like, and epichlorohydrin. Further examples may include a multifunctional epoxy compound such as an epoxidized phenol novolac resin, an epoxidized cresol novolac resin, and epoxidized polyolefin, and a monofunctional epoxy compound such as butyl glycidyl ether, phenyl glycidyl ether, and glycidyl methacrylate. However, the above-described epoxy compound using as latent catalyst in the present invention is not limited to these examples.

An amine compound used as another raw material for manufacturing the amine adduct latent catalyst may be any compound which has in its molecule one or more active hydrogens which can undergo an addition reaction with an epoxy group and has in its molecule one or more functional groups selected from a primary amino group, a secondary amino group, and a tertiary amino group. Examples of such an amine compound will be indicated below. Examples thereof may include aliphatic amines such as diethylenetriamine, triethylenetetramine, n-propylamine, 2-hydroxyethyl aminopropylamine, cyclohexylamine, and 4,4′-diamino-dicyclohexylmethane, an aromatic amine compound such as 4,4′-diaminodiphenylmethane and 2-methylaniline, and a nitrogen atom-containing heterocyclic compound such as 2-ethyl-4-methylimidazole, 2-ethyl-4-methylimidazoline, 2,4-dimethylimidazoline, piperidine, and piperazine. However, the above-described amine compound using as latent catalyst in the present invention is not limited to these examples.

Examples of such a compound may include primary or secondary amines having in its molecule a tertiary amino group, such as an amine compound such as dimethylaminopropylamine, diethylaminopropylamine, di-propylaminopropylamine, dibutylaminopropylamine, dimethylaminoethylamine, diethylaminoethylamine, and N-methylpiperazine, and an imidazole compound such as 2-methylimidazole, 2-ethylimidazole, 2-ethyl-4-methylimidazole, and 2-phenylimidazole. Further examples may include alcohols, phenols, thiols, carboxylic acids, hydrazides, and the like, which have in its molecule a tertiary amino group, such as 2-dimethylaminoethanol, 1-methyl-2-dimethylaminoethanol, 1-phenoxymethyl-2-dimethylaminoethanol, 2-diethylaminoethanol, 1-butoxymethyl-2-dimethylaminoethanol, 1-(2-hydroxy-3-phenoxypropyl)-2-methylimidazole, 1-(2-hydroxy-3-phenoxypropyl)-2-ethyl4-methylimidazole, 1-(2-hydroxy-3-butoxypropyl)-2-methylimidazole, 1-(2-hydroxy-3-butoxypropyl)-2-ethyl-4-methylimidazole, 1-(2-hydroxy-3-phenoxypropyl)-2-phenylimidazoline, 1-(2-hydroxy-3-butoxypropyl)-2-methylimidazoline, 2-(dimethylaminomethyl)phenol, 2,4,6-tris(dimethylaminomethyl)phenol, N-nhydroxyethylmorpholine, 2-dimethylaminoethanethiol, 2-mercaptopyridine, 2-benzoimidazole, 2-mercaptobenzoimidazole, 2-mercaptobenzothiazole, 4-mercaptopyridine, N,N-dimethylaminobenzoic acid, N,N-dimethylglycine, nicotinic acid, isonicotinic acid, picolinic acid, N,N-dimethylglycine hydrazide, N,N-dimethylpropionic acid hydrazide, nicotinic acid hydrazide, and isonicotinic acid hydrazide. However, the above-described compound having in its molecule a tertiary amino group using as latent catalyst in the present invention is not limited to these examples.

Examples of an isocyanate compound used as further another raw material of the amine adduct latent catalyst include, but not limited to, a monofunctional isocyanate compound such as n-butyl isocyanate, isopropyl isocyanate, phenyl isocyanate, and benzyl isocyanate, and a multifunctional isocyanate compound such as hexamethylene diisocyanate, toluene diisocyanate, 1,5-naphthalene diisocyanate, diphenylmethane-4,4′-diisocyanate, isophorone diisocyanate, xylyl ene diisocyanate, paraphenylene diisocyanate, 1,3, 6-hexamethylene triisocyanate, and bicycloheptane triisocyanate. Furthermore, there can be used a compound containing at its terminal an isocyanate group, which is obtained by the reaction between these multifunctional isocyanate compounds and an active hydrogen compound. Examples of such a compound containing at its terminal an isocyanate group may include an adduct compound having at its terminal an isocyanate group, which is obtained by the reaction between toluene diisocyanate and trimethylolpropane, and an adduct compound having at its terminal an isocyanate group, which is obtained by the reaction between toluene diisocyanate and pentaerythritol. However, the above-described compound containing at its terminal an isocyanate group using as amine adduct latent catalyst in the present invention is not limited to these examples.

Example of a urea compound used as a raw material for producing amine adduct latent catalyst include, but not limited to, urea, urea phosphate, urea oxalate, urea acetate, diacetyl urea, dibenzoylurea, and trimethylurea.

Commercial examples of the above-described amine adduct latent catalyst include Ajicure PN-23 available from Ajinomoto FineTechno Co., Inc., Ajicure PN-40 available from Ajinomoto Fine-Techno Co., Inc., Ajicure PN-50 available from Ajinomoto FineTechno Co., Inc., Hardener X-3661 S available from A.C.R. Co., Ltd, Hardener X-3670S available from A.C.R. Co., Ltd, EH-5011S and EH5057P available from Adeka, Ancamine® 2014FG and 2337S available from Evonik, FXR-1121 available from T&K Toka Corporation, Fujicure FXE-1000 available from T&K Toka Corporation as well as Fujicure FXR-1030 available from T&K Toka Corporation.

Further, the core-shell type latent amine catalyst is obtained by further treating the surface of an amine adducts with acid compounds such as a carboxylic acid compound and a sulfonic acid compound, isocyanate compounds or epoxy compounds to form a shell of a modified product (adducts, etc.) onto the surface. Further, the master batch type latent amine catalyst is the core-shell type latent catalyst in a state of being mixed with an epoxy resin.

Commercially examples of the above-described core-shell type latent amine catalysts and master batch type latent amine catalysts include Fujicure FXR 1081 available from T&K Toka Corporation, Novacure HX-3722 available from Asahi Kasei Epoxy Co., Ltd., Novacure HX-3742 available from Asahi Kasei Epoxy Co., Ltd., Novacure HX-3613 available from Asahi Kasei Epoxy Co., Ltd., and the like.

The latent amine catalyst can be used alone. Alternatively, two or more types of the components may be used in combinations.

According to the present invention, the component (C) may present in an amount of from 3% to 47% by weight, more preferably from 7% to 40% by weight, even more preferably from 13% to 35% by weight, based on the total weight of the composition.

### (D) Additive

In some embodiments, the curable composition may further comprise (D) at least one additive selected from curing reaction inhibitors, pigments, dyes, fluorescent dyes, heat resistant additives, flame retardants, plasticizers, adhesion-imparting agents, fillers, and combinations thereof.

Suitable examples of curing reaction inhibitor used in the present invention, including but not limited to barbituric acid, acetylene-based compound selected from 2-methyl-3-butyn-2-ol, 2-phenyl-3-butyn-2-ol, or 1-ethynyl-1-cyclohexanol; an ene-in compound such as 3-methyl-3-penten-1-in, 3,5-dimethyl-3-hexen-1-in, and combinations thereof; hydrazine-based compound; phosphine-based compound; mercaptan-based compound; and combinations thereof.

Suitable commercially available curing reaction inhibitor include PM 182 from Henkel, 3,5-dimethyl-1-hexyn-3-ol from Sigma-Aldrich Company.

Examples of useful pigments include inorganic, organic, reactive, and nonreactive pigments, and combinations thereof, which may be selected from metal oxide pigments, titanium dioxide, optionally surface-treated, zirconium oxide or cerium oxide, zinc oxide, iron oxide (black, yellow or red), chromium oxide, manganese.

As necessary, the curable composition can be, without impairing the objective of the present invention, mixed with a filler such as a silica filler, a stabilizing agent, carbon black, titanium black, a silane coupling agent, an ion trapping agent, a leveling agent, an antioxidant, an antifoaming agent, a thixotropic agent, and other additives.

In those cases where the composition of the present invention comprises component (D), there are no particular restrictions on the quantity, although a quantity within a range from 0% to 10% by weight, more preferably from 0.1% to 5% by weight, even more preferably from 1% to 3% by weight, based on the total weight of the composition is preferred.

### (E) Photo Radical Polymerization Initiator

According to the present invention, the curable composition may further comprise (E) at least one photo radical polymerization initiator; if present, the curing process may then be initiated by UV radiation.

In some embodiments, both photo initiation and thermal initiation may be desirable. For example, the curing process can be started by UV irradiation and in a later processing step, curing can be completed by the application of heat to accomplish further curing.

Useful photo radical polymerization initiators include, but not limited to, α-cleavage (Type I) photo radical polymerization initiator, hydrogen abstracting photo radical polymerization initiator, and combinations thereof. Examples of α-cleavage (Type I) photo radical polymerization initiator are benzyl dimethyl ketal, benzoin ethers, hydroxy alkyl phenyl ketones, benzoyl cyclohexanol, dialkoxy acetophenones, 1-hydroxycyclohexyl phenyl ketone, trimethylbenzoyl phosphine oxides, methyl thio phenyl morpholino ketones and morpholino phenyl amino ketones, and combinations thereof. Examples of hydrogen abstracting photo radical polymerization initiator are benzophenones, thioxanthones, benzyls, camphorquinones, ketocoumarins; and combinations thereof.

Preferred photo radical polymerization initiators include ketone derivatives, e.g., 1-hydroxycyclohexyl phenyl ketone.

These photo radical polymerization initiators may be used alone or two or more of them may be used in combinations.

Useful commercially available photo radical polymerization initiators are available under the following trade designations IRGACURE® 184, IRGACURE® 127, IRGACURE® 819, IRGACURE® 754, and IRGACURE® 500, DAROCUR® 4265 from BASF.

In general, when photo radical polymerization initiator is present in the compositions, these compositions will be cured at room temperature within a length of time of less than 30 seconds, preferably less than 10 seconds, more preferably less than 5 seconds at wavelength in a range from 200 nm to 650 nm, preferably from 300 to 500 nm, followed by a heating curing process described herein. As will be understood, the time and wavelength curing profile for each curable composition will vary, and different compositions can be designed to provide the curing profile that will be suited to the particular industrial manufacturing process.

With particular preference, the component (E) if present, can be in an amount of from 0% to 10% by weight, preferably from 0.1% to 7% by weight, based on the total weight of the composition.

### Composition

In particular preferred embodiments, the curable composition, based on the total weight of the composition, comprises:
(A) from 50% to 95% by weight, preferably from 60% to 85% by weight of at least one (meth)acrylate,
(B) from larger than 0% to less than 3% by weight, preferably from 0.001% to 2% by weight, more preferably from 0.01% to 2% by weight of at least one diaryliodonium salt,
(C) from 3% to 47% by weight, more preferably from 7% to 40% by weight, even more preferably from 13% to 35% by weight of at least one latent amine catalyst,
(D) from 0% to 10% by weight, more preferably from 0.1% to 5% by weight, even more preferably from 1% to 3% by weight of at least one additive, and
(E) from 0% to 10% by weight, preferably from 0.1% to 7% by weight of at least one photo radical polymerization initiator.

### Preparation Method of Curable Composition

The curable composition according to the present invention can be prepared at room temperature by the following steps:
(i) mixing component (B), component (E) (if present) with component (A) in an apparatus to obtain homogeneous mixture,
(ii) if component (D) is present, adding component (D) into the mixture obtained by step (i); and
(iii) lastly adding component (C) and stirring the mixture uniformly to obtain the composition.

The apparatuses for these mixing, stirring, dispersing, and the like are not particularly limited. There can be used an automated mortar, a Henschel mixer, a three-roll mill, a ball mill, a planetary mixer, a bead mill, and the like which are equipped with a stirrer and a heater. Also, an appropriate combination of these apparatuses may be used. The preparation method of the curable composition is not particularly limited, as long as a composition in which the above-described components are uniformly mixed can be obtained.

### Curing Profile and Cured Product

According to the present invention, the curable composition of the present invention can be thermally curable, preferably at a temperature of lower than 100° C., more preferably of lower than 80° C.

In some embodiments, the curable composition of the present invention can be thermally curable from 40° C. to 95° C., preferably from 40° C. to 85° C.

Inventors surprisingly found out that although diaryliodonium salt releases free radicals after heating to above 100° C. which is able to initiate free radical polymerization of (meth)acrylate, the reaction temperature can be greatly decreased when a latent amine catalyst is present in the reaction.

According to the present invention, the curable composition of the present invention can be thermally curable and radiation curable if at least one photo radical polymerization initiator is present.

In preferred embodiments, the curable composition of the present invention can be cured by UV radiation at room temperature within a length of time of less than 30 seconds, preferably less than 10 seconds, more preferably less than 5 seconds at wavelength in a range from 200 nm to 650 nm, preferably from 250 nm to 500 nm; and then followed by thermally cured at temperature of lower than 100° C., preferably from 60° C. to 90° C., preferably from 62° C. to 82° C. for from 20 mins to 3 hours. As will be understood, the time and temperature curing profile for each adhesive composition will vary, and different compositions can be designed to provide the curing profile that will be suited to the particularly industrial manufacturing process.

In another aspect of the present invention, the cured product of the curable composition according to the present invention is provided.

### Article, Electronic Device and the Use Thereof

In another aspect of the present invention, provided is an article comprising a first substrate, a cured product, and a second substrate bonded to the first substrate through the cured product derived from the curable composition according to the present invention.

The first substrate and/or second substrate can be of a single material and a single layer or can include multiple layers of the same or different material. The layers can be continuous or discontinuous.

The substrates of the article descried herein can have a variety of properties including rigidity (e.g., rigid substrates i.e., the substrate cannot be bent by an individual using two hands or will break if an attempt is made to bend the substrate with two hands), flexibility (e.g., flexible substrates i.e., the substrate can be bent using no greater than the force of two hands), porosity, conductivity, lack of conductivity, and combinations thereof.

The substrates of the article can be in a variety of forms including, e.g., fibers, threads, yarns, wovens, nonwovens, films (e.g., polymer film, metallized polymer film, continuous films, discontinuous films, and combinations thereof), foils (e.g., metal foil), sheets (e.g., metal sheet, polymer sheet, continuous sheets, discontinuous sheets, and combinations thereof), and combinations thereof.

Useful substrate material used in the present invention include, e.g., polymer (e.g., polycarbonate, ABS resin (Acrylonitrile-Butadiene-Styrene resin), liquid crystal polymer, polyolefin (e.g., polypropylene, polyethylene, low density polyethylene, linear low density polyethylene, high density polyethylene, polypropylene, and oriented polypropylene, copolymers of polyolefins and other comonomers), polyether terephthalate, ethylene-vinyl acetate, ethylene-methacrylic acid ionomers, ethylene-vinyl-alcohols, polyesters, e.g. polyethylene terephthalate, polycarbonates, polyamides, e.g. Nylon-6 and Nylon-6,6, polyvinyl chloride, polyvinylidene chloride, cellulosics, polystyrene, and epoxy), polymer composites (e.g., composites of a polymer and metal, cellulose, glass, polymer, and combinations thereof), metal (aluminum, copper, zinc, lead, gold, silver, platinum, and magnesium, and metal alloys such as steel (e.g., stainless steel), tin, brass, and magnesium and aluminum alloys), carbon-fiber composite, other fiber-based composite, graphene, fillers, glass (e.g., alkali-aluminosilicate toughened glass and borosilicate glass), quartz, boron nitride, gallium nitride, sapphire, silicon, carbide, ceramic, and combinations thereof, preferably liquid crystal polymer, glass and combinations thereof.

The curable composition can be applied to a substrate using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The curable composition can be applied as a continuous or discontinuous coating, in a single or multiple layers and combinations thereof.

Optionally, the surface of the substrate on which the curable adhesive composition is applied is treated to enhance adhesion using any suitable method for enhancing adhesion to the substrate surface including, e.g., corona treatments, chemical treatments (e.g., chemical etching), flame treatments, abrasion, and combinations thereof.

In an additional aspect of the invention, provided is an electronic device comprising the article of the present invention.

Exemplary electronic devices encompass computers and computer equipment, such as printers, fax machines, scanners, keyboards and the like; medical sensors; automotive sensors and the like; wearable electronic devices (e.g., wrist watches and eyeglasses), handheld electronic devices (e.g., phones (e.g., cellular telephones and cellular smartphones), cameras, tablets, electronic readers, monitors (e.g., monitors used in hospitals, and by healthcare workers, athletes and individuals), watches, calculators, mice, touch pads, and joy sticks), computers (e.g., desk top and lap top computers), computer monitors, televisions, media players, household appliances (e.g., refrigerators, washing machines, dryers, ovens, and microwaves), light bulbs (e.g., incandescent, light emitting diode, and fluorescent), and articles that include a visible transparent or transparent component, glass housing structures, protective transparent coverings for a display or other optical component.

In yet another aspect of the invention, the use of the curable adhesive composition and the article according to this invention in manufacturing electronic devices is provided.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials:

SR 833S is tricyclodecane dimethanol diacrylate, available from Sartomer.
PEP 9000 is a urethane (meth)acrylate, available from Negami Chemical Industrial Co., Ltd.
Irgacure 184 is 1-hydroxycyclohexyl phenyl ketone, available from BASF.
Rhodorsil Photoinitiator 2074 is 4-isopropyl-4′-methyldiphenyliodonium tetrakis(pentafluorophenyl)borate, available RHODIA INC.
Omnicat 250 is 4-isobutylphenyl-4′-methylphenyliodonium hexafluorophosphate iodonium, available from IGM Resins.
CPI-200K is triarylsulfonium salt with phosphate anion, available from San-Apro Ltd.
Cyracure UVI 6976 is a mixed type triarylsulfonium hexafluoroantimonate salt, available from DOW.
2-(Acetyloxy)-5-iodobenzoic acid is available from Sigma Aldrich.
Iodobenzene is available from Sigma Aldrich.
Fujicure FXR 1081 is a mixture of aliphatic polyamine and cycloaliphatic polyamine, available from T&K Toka Corporation.
2E4MZ-CN is 1-cyanoethyl-2-ethyl-4-methylimidazole, available from Shikoku Chemicals.
PM 182 is barbituric acid, available from Henkel.

### Preparation Method:

### Example 1 (Ex.1)

0.08 g Rhodorsil Photoinitiator 2074 was mixed with 3 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.1 g PM 182 was added in the container and the mixture was mixed under the speed of 1000 rpm for 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the curable composition.

### Example 2 (Ex.2)

0.08 g Omnicat 250 was mixed with 3 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.1 g PM 182 was added in the container and the mixture was mixed under the speed of 1000 rpm for 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the curable composition.

### Example 3 (Ex.3)

0.04 g Rhodorsil Photoinitiator 2074 was mixed with 3 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.1 g PM 182 was added in the container and the mixture was mixed under the speed of 1000 rpm for 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the curable composition.

### Example 4 (Ex.4)

0.005 g Rhodorsil Photoinitiator 2074 was mixed with 3 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.1 g PM 182 was added in the container and the mixture was mixed under the speed of 1000 rpm for 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the curable composition.

### Example 5 (Ex.5)

0.08 g Rhodorsil Photoinitiator 2074 was mixed with 3 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.1 g PM 182 was added in the container and the mixture was mixed under the speed of 1000 rpm for 5 minutes. Afterwards, 0.5 g Fujicure FXR 1081 was added and mixed at 1000 rpm for 5 minutes. Lastly, Thinky ARV-310 mixer was used to remove bubbles from homogeneous mixture to get the curable composition.

### Example 6 (Ex.6)

0.08 g Rhodorsil Photoinitiator 2074 was mixed with 3 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.1 g PM 182 was added in the container and the mixture was mixed under the speed of 1000 rpm for 5 minutes. Afterwards, 0.1 g Fujicure FXR 1081 was added and mixed at 1000 rpm for 5 minutes. Lastly, Thinky ARV-310 mixer was used to remove bubbles from homogeneous mixture to get the curable composition.

### Example 7 (Ex.7)

1 g PEP 9000 was mixed with 2 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.08 g Rhodorsil Photoinitiator 2074 and 0.15 g Irgacure® 184 was added in and the mixture was mixed under the speed of 1000 rpm for 5 minutes. Then 0.1 g PM 182 was added in the container and the mixture was mixed under the speed of 1000 rpm for another 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the curable composition.

### Example 8 (Ex.8)

1 g PEP 9000 was mixed with 2 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.08 g Omnicat 250 and 0.15 g Irgacure® 184 was added in and the mixture was mixed under the speed of 1000 rpm for 5 minutes. Then 0.1 g PM 182 was added in the container and the mixture was mixed under the speed of 1000 rpm for another 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the curable composition.

### Example 9 (Ex.9)

1 g PEP 9000 was mixed with 2 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.08 g Rhodorsil Photoinitiator 2074 and 0.15 g Irgacure® 184 was added in and the mixture was mixed under the speed of 1000 rpm for 5 minutes. Then 0.1 g PM 182 was added in the container and the mixture was mixed under the speed of 1000 rpm for another 5 minutes. Afterwards, 0.3 g Fujicure FXR 1081 was added and mixed at 1000 rpm for 5 minutes. Lastly, Thinky ARV-310 mixer was used to remove bubbles from homogeneous mixture to get the curable composition.

### Example 10 (Ex.10)

1 g PEP 9000 was mixed with 2 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.04 g Rhodorsil Photoinitiator 2074 and 0.15 g Irgacure® 184 was added in and the mixture was mixed under the speed of 1000 rpm for 5 minutes. Then 0.1 g PM 182 was added in the container and the mixture was mixed under the speed of 1000 rpm for another 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the curable composition.

### Comparative Example 1 (CEx.1)

0.08 g Rhodorsil Photoinitiator 2074 was mixed with 3 g SR 833S in a container covered with a lid. The mixture was stirred in Speedmixer DAC 150.1 FVZ-K (manufactured by FlackTek, Inc.) under the speed of 2000 rpm for 10 minutes at room temperature to get the curable composition.

### Comparative Example 2 (CEx.2)

3 g SR 833S was prepared in a container covered with a lid. Then 1 g Fujicure FXR 1081 was added and the mixture was stirred in Speedmixer DAC 150.1 FVZ-K (manufactured by FlackTek, Inc.) under the speed of 2000 rpm for 10 minutes at room temperature to get the composition.

### Comparative Example 3 (CEx.3)

0.08 g CPI-200K was mixed with 3 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.1 g PM 182 was added in the container and the mixture was mixed under the speed of 1000 rpm for 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the composition.

### Comparative Example 4 (CEx.4)

0.08 g Cyracure UVI 6976 was mixed with 3 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.1 g PM 182 was added in the container and the mixture was mixed under the speed of 1000 rpm for 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the composition.

### Comparative Example 5 (CEx.5)

0.08 g Iodobenzene was mixed with 3 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.1 g PM 182 was added in the container and the mixture was mixed under the speed of 1000 rpm for 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the composition.

### Comparative Example 6 (CEx.6)

0.08 g 2-(Acetyloxy)-5-iodobenzoic acid was mixed with 3 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.1 g PM 182 was added in the container and the mixture was mixed under the speed of 1000 rpm for 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the curable composition.

### Comparative Example 7 (CEx.7)

0.08 g Rhodorsil Photoinitiator 2074 was mixed with 3 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.1 g PM 182 was added in the container and the mixture was mixed under the speed of 1000 rpm for 5 minutes. Afterwards, 0.5 g 2E4MZ-CN was added and mixed at 1000 rpm for 5 minutes. Lastly, Thinky ARV-310 mixer was used to remove bubbles from homogeneous mixture to get the curable composition.

### Comparative Example 8 (CEx.8)

1 g PEP 9000 was mixed with 2 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.08 g Rhodorsil Photoinitiator 2074 and 0.01 g Irgacure® 184 was added in and the mixture was mixed under the speed of 1000 rpm for 5 minutes. Lastly, Thinky ARV-310 mixer was used to remove bubbles from homogeneous mixture to get the curable composition.

### Comparative Example 9 (CEx.9)

1 g PEP 9000 was mixed with 2 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.01 g Irgacure® 184 was added in and the mixture was mixed under the speed of 1000 rpm for 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the composition.

### Comparative Example 10 (CEx.10)

1 g PEP 9000 was mixed with 2 g SR 833S in a container covered with a lid. The mixture was stirred in Speedmixer DAC 150.1 FVZ-K (manufactured by FlackTek, Inc.) under the speed of 2000 rpm for 10 minutes at room temperature. Then 0.08 g Cyracure UVI 6976 and 0.15 g Irgacure® 184 was added in and the mixture was mixed under the speed of 1000 rpm for 5 minutes. Then 0.1 g PM 182 was added in the container and the mixture was mixed under the speed of 1000 rpm for another 5 minutes. Afterwards, 1 g Fujicure FXR 1081 was added and mixed at 1000 rpm for 5 minutes. Lastly, Thinky ARV-310 mixer was used to remove bubbles from homogeneous mixture to get the composition.

### Test Methods:

### Differential Scanning Calorimetry (DSC)

Each formulation of from Ex.1 to Ex.6 and CEx.1 to CEx.7 was measured by dynamic DSC Q2000 instrument to determine the curing temperature, wherein the measurement conditions are the following: scanning temperature range from 40° C. to 250° C. with 10° C./min. The peak temperature was recorded in Table 1.

A DSC peak temperature of less than 100° C. can be acceptable.

### Die Shear Strength of the Cured Product

The Die Shear Strength (DSS) of the cured product was measured using DAGE4000 (manufactured from Nordson Corporation) at room temperature. The compositions of the present invention and comparative examples were coated onto a glass upper-adherend 3*3 mm² with the thickness of 0.8 mm. Then placed the glass upper adherend onto the polyamide substrate. All samples of each composition from Ex.1 to Ex.6 and CEx.1 to CEx.7 were cured an oven for 1 hour at 80° C. All samples of each composition from Ex.7 to Ex.10 and CEx.8 and CEx.10 were cured under UV radiation for 2 s at 1100 mw/cm 2 in the wavelength of 365 nm LED light and then followed by thermal cure at an oven for 1 hour at 80° C. No pressure was used. Each sample was tested eight times under the same condition and the average DSS was calculated and recorded by simplistic average method so as to eliminate error. The test results are shown in Table 1 and Table 2.

From Ex.1 to Ex.6 and CEx.1 to CEx.7, a DSS of larger than 5 Kg can be acceptable. From Ex.7 to Ex.10 and CEx.8 and CEx.10, a DSS of larger than 5 Kg can be acceptable.

TABLE 1

| Performance | Ex. 1 | Ex. 2 | Ex. 3 | Ex. 4 | Ex. 5 | Ex. 6 | CEx. 1 | CEx. 2 | CEx. 3 | CEx. 4 | CEx. 5 | CEx. 6 | CEx. 7 |
|---|---|---|---|---|---|---|---|---|---|---|---|---|---|
| DSC Peak | 71 | 64 | 75 | 80 | 84 | 94 | 181 | ND | ND | ND | ND | 49 | 75 |
| Temperature | | | | | | | | | | | | | |
| (° C.) | | | | | | | | | | | | | |
| DSS (Kg) | 14.02 | 12 | 8.9 | 9.2 | 10.7 | 9.8 | 0.19 | 0.69 | 0.45 | 1.34 | 0.27 | N/A | 4.9 |

TABLE 2

| Performance | Ex. 7 | Ex. 8 | Ex. 9 | Ex. 10 | CEx. 8 | CEx. 9 | CEx. 10 |
|---|---|---|---|---|---|---|---|
| DSS (Kg) | 10.1 | 14.2 | 10.2 | 8.8 | 2.7 | 3.1 | 4.8 |

Remarks:
1. ND refers to non-detectable in Table 1. For those compositions with non-detectable DSC peak temperature, the components in the composition may not reactive, if so, the DSS in the Table 1 and 2 may be the strength of the components in the respective composition.
2. For CEx.6, the composition was rapidly cured to form a gel at room temperature in a few minutes, therefore the DSS cannot be detected by the present method described herein.

As can be seen from Table 1, the curable composition of the present invention showed lower curing temperature (less than 100° C.) than the comparative composition, and the cured product of the curable composition in the present invention showed good die shear strength (larger than 5 Kg).

As can be seen from Table 2, the curable composition of the present invention can be thermally curable and radiation curable and showed desired die shear strength (larger than 5 Kg).

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A curable composition comprising:
(A) at least one (meth)acrylate;
(B) at least one diaryliodonium salt; and
(C) at least one latent amine catalyst.

2. The curable composition according to claim 1, wherein the component (A) is selected from monofunctional (meth)acrylate monomers, polyfunctional (meth)acrylate monomers and oligomers thereof.

3. The curable composition according to claim 2, wherein the monofunctional (meth)acrylate monomer is selected from methyl (meth)acrylate, (meth)acrylic acid, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth) acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth) acrylate, tricyclodecanyl (meth)acrylate, dicyclopentenyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-phenoxyethyh acrylate, 2-aminoethyl (meth)acrylate, dimethylaminoethyl (meth)acrylate, diethylaminoethyl (meth)acrylate, and combinations thereof.

4. The curable composition according to claim 2, wherein the polyfunctional (meth)acrylate monomer is selected from ethoxylated trimethylolpropane triacrylate, trimethylol propane tri(meth)acrylate, dipentaerythritol pentaacrylate, pentaerythritol triacrylate, 1,6-hexanedioldiacrylate, neopentyl glycol diacrylate, pentaerythritol tetraacrylate, 1,4-butanediol diacrylate, trimethylolpropane tri(meth)acrylate, tri(propylene glycol) diacrylate, neopentyl glycol propoxylate diacrylate, diethylene glycol dimethacrylate, bisphenol A diglycidyl ether di(meth)acrylate, dicyclopentadiene dimethanol di(meth)acrylate, tricyclodecanedimethanol diacrylate, and combinations thereof.

5. The curable composition according to claim 1, wherein the component (B) is selected from diphenyl iodonium phosphate, diphenyl iodonium borate, and the combination thereof; preferably selected from (4-methylphenyl)-[4-(2-methylpropyl)phenyl]iodonium hexafluorophosphate, (4-methylphenyl)-phenyliodonium hexafluorophosphate, bis(4-tert-butylphenyl)iodonium hexafluorophosphate, bis(4-methylphenyl)iodonium hexafluorophosphate, (4-ethylphenyl)-[4-(2-methylpropyl)phenyl]iodoniumhexafluorophosphate, bis(t-butylphenyl)iodonium hexafluorophosphate, bis(3,4-dimethylphenyl)iodonium hexafluorophosphate, (4-isopropylphenyl)(p-tolyl)iodonium tetrakis(perfluorophenyl)borate, (4-methylphenyl)-(2-propan-2-ylphenyl)iodonium tetrakis(2,3,4,5,6-pentafluorophenyl)boranuide, bis(2-methylphenyl)iodonium tetrakis(2,3,4,5,6-pentafluorophenyl)boranuide, (4-methylphenyl)-[4-(2-methylpropyl)phenyl]iodonium tetrakis(2,3,4,5,6-pentafluorophenyl)boranuide, bis(4-dodecylphenyl)iodonium tetrakis(2,3,4,5,6-pentafluorophenyl)boranuide, bis(2-dodecylphenyl)iodonium tetrakis(2,3,4,5,6-pentafluorophenyl)boranuide, (2-methylphenyl)-(2-propan-2-ylphenyl)iodonium tetrakis(2,3,4,5,6-pentafluorophenyl)boranuide, bis(2-tert-butylphenyl)iodonium tetrakis(2,3,4,5,6-pentafluorophenyl)boranuide, 1,4-di(3-phenylpropyl)-2,3-diperfluorophenyl-1,4-diiodobutadiene, butyl(triphenyl)boranuide (4-cyclohexylphenyl)-(4-methylphenyl)iodonium, (4-hexylphenyl)-phenyliodonium tetraphenylboranuide, (4-cyclohexylphenyl)-phenyliodonium tetraphenylboranuide, and combinations thereof.

6. The curable composition according to claim 1, wherein the component (C) is selected from amine adduct latent amine catalyst, preferably obtained by the reaction products of an amine compound with an epoxy compound, an isocyanate compound and/or a urea compound; core-shell type latent amine catalyst; master batch type latent amine catalyst; and combinations thereof.

7. The curable composition according to claim 1, wherein the composition further comprises (D) at least one additive selected from curing reaction inhibitors, pigments, dyes, fluorescent dyes, heat resistant additives, flame retardants, plasticizers, adhesion-imparting agents, fillers, and combinations thereof.

8. The curable composition according to claim 1, wherein the composition is thermally curable.

9. The curable composition according to claim 1, wherein the composition further comprises (E) at least one photo radical polymerization initiator.

10. The curable composition according to claim 9, wherein the photo radical polymerization initiator is α-cleavage photo radical polymerization initiator, hydrogen abstracting photo radical polymerization initiator and combinations thereof, preferably selected from benzyl dimethyl ketal, benzoin ethers, hydroxy alkyl phenyl ketones, benzoyl cyclohexanol, dialkoxy acetophenones, 1-hydroxycyclohexyl phenyl ketone, trimethylbenzoyl phosphine oxides, methyl thio phenyl morpholino ketones and morpholino phenyl amino ketones, benzophenones, thioxanthones, benzyls, camphorquinones, ketocoumarins; and combinations thereof.

11. The curable composition according to claim 9, wherein the composition is thermally curable and radiation curable.

12. The curable composition according to claim 1, wherein the component (A) is present in an amount of from 50% to 95% by weight based on the total weight of the composition.

13. The curable composition according to claim 1, wherein the component (B) is present in an amount of from larger than 0% to less than 3% by weight based on the total weight of the composition.

14. The curable composition according to claim 1, wherein the component (C) is present in an amount of from 3% to 47% by weight based on the total weight of the composition.

15. The curable composition according to claim 1, wherein the component (D) is present in an amount of from larger than 0% to 10% by weight based on the total weight of the composition.

16. The curable composition according to claim 1, wherein the component (E) is present in an amount of from 0% to 10% by weight based on the total weight of the composition.

17. Cured product of a curable composition according to claim 1.

18. An article comprising:
a first substrate,
a cured product according to claim 17, and
a second substrate bonded to the first substrate through the cured product.

19. An electronic device comprising the article according to claim 18.
